(19) United States
(12) Patent Application Publication
(10) Pub. No.: US 2009/0207399 A1
(43) Pub. Date: Aug. 20, 2009

(54) Lithographic method

(75) Inventors: Alex F. Fong, San Jose, CA (US); Henricus Wilhelmus Maria Van Buel, s-Hertogenbosch (NL); Joseph J. Consolini, Costa Mesa, CA (US); Michael Josephus Evert Van De Moosdijk, Eindhoven (NL); Michael Charles Robles, Santa Cruz, CA (US)

Correspondence Address: PILLSBURY WINTHROP SHAW PITTMAN, LLP, P.O. BOX 10500, MCLEAN, VA, 22102, US

(73) Assignees: ASML NETHERLANDS B.V., Veldhoven (NL); ASML Holding NV, Veldhoven (NL)

(21) Appl. No.: 12/318,035

(22) Filed: Dec. 19, 2008

Related U.S. Application Data
(60) Provisional application No. 61/006,118, filed on Dec. 19, 2007.

(51) Int. Cl. G03B 27/58; G01B 11/00

(52) U.S. Cl. 355/72; 356/401

(57) ABSTRACT

A method of calibrating a front to backside alignment capable lithographic apparatus. The method includes attaching a substrate having a plurality of alignment marks to a carrier, the substrate being arranged such that the alignment marks face towards the carrier; reducing the thickness of the substrate; using an alignment system of the apparatus to measure the positions of images of alignment marks formed by optics in a substrate table of the apparatus; projecting a pattern onto the substrate, the position of the pattern being determined according to the measured positions of the alignment marks; measuring the positions of the projected pattern and the alignment marks provided on the opposite side of the substrate, the position of the alignment marks provided on the opposite side of the substrate being measured by the alignment system directing radiation through the substrate; and comparing the measured positions in order to determine an overlay error.

### CROSS-REFERENCE TO RELATED APPLICATIONS

This application claims the benefit of priority from U.S. provisional patent application Ser. No. 61/006,118, filed on Dec. 19, 2007, the entire content of which is incorporated herein by reference.

### FIELD

The present invention relates to a lithographic method, a substrate, and a substrate carrier.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

In conventional lithography a plurality of patterned layers are provided on one side of a substrate. However, in some instances it is useful to provide patterned layers on both sides of the substrate (for example when making some MEMs devices). In order to do this, a lithographic apparatus may be used which is capable of projecting onto an upper surface of a substrate a pattern which is aligned with alignment marks on a lower surface of the substrate. Known methods of calibrating the alignment achieved using a lithographic apparatus of this type are slow and/or expensive.

It is desirable to provide a method which obviates or mitigates one or more of the problems of the prior art, whether identified herein or elsewhere.

### SUMMARY

According to an aspect of the invention, there is provided a method of calibrating a front to backside alignment capable lithographic apparatus. The method includes attaching a substrate with a plurality of alignment marks to a carrier. The substrate is arranged such that the alignment marks face towards the carrier. The method also includes reducing the thickness of the substrate by removing part of the substrate, and introducing the substrate and the carrier into the lithographic apparatus. The method also includes using an alignment system of the lithographic apparatus to measure the positions of images of alignment marks formed by optics in a substrate table of the lithographic apparatus. The method further includes projecting a pattern onto the substrate. The position of the pattern is determined according to the measured positions of the alignment marks. The method also includes measuring the position of the projected pattern and the position of alignment marks provided on the opposite side of the substrate. The position of the alignment marks provided on the opposite side of the substrate is measured by the alignment system directing radiation through the substrate. The method further includes comparing the measured positions in order to determine an overlay error which arises from the optics in a substrate table of the lithographic apparatus.

According to a further aspect of the invention, there is provided a substrate and carrier. The substrate is attached to the carrier and is sufficiently thin that an alignment system of a lithographic apparatus is capable of viewing alignment marks provided on an opposite side of the substrate from the alignment system by directing radiation through the substrate.

According to a further aspect of the invention, there is provided a substrate carrier arranged to hold a substrate. The substrate carrier is provided with a plurality of openings which pass from an upper surface of the substrate carrier to a lower surface of the substrate carrier. The openings are positioned such that in use alignment marks provided on an underside of the substrate are located over the openings.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus which may be used to perform embodiments of the invention;

FIG. 2 depicts an embodiment of a substrate table of the lithographic apparatus of FIG. 1;

FIGS. 3a-3e depicts a method of forming a substrate and carrier according to an embodiment of the invention;

FIG. 4 depicts the substrate and an embodiment of the carrier on the substrate table of the lithographic apparatus; and

FIG. 5 depicts the substrate and an embodiment of the carrier on the substrate table of the lithographic apparatus.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

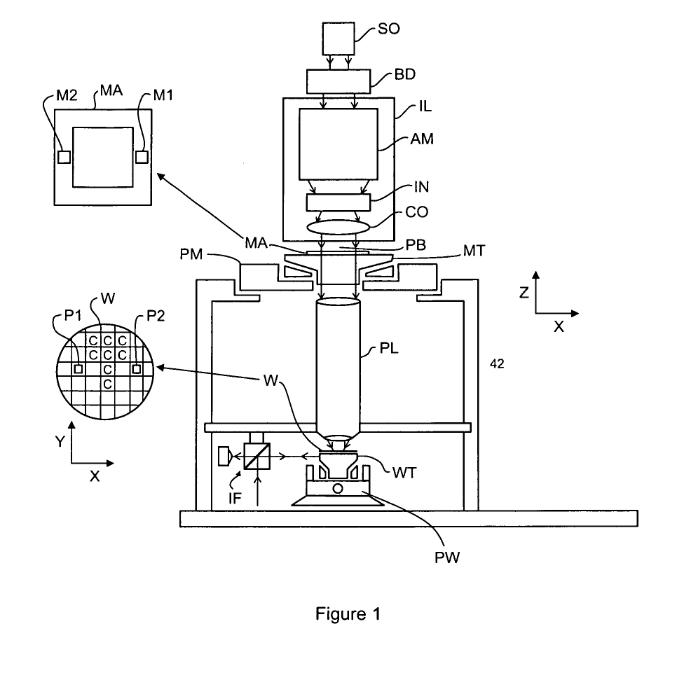

FIG. 1 schematically depicts a lithographic apparatus according to a particular embodiment of the invention. The apparatus comprises: an illumination system (illuminator) IL to condition a beam PB of radiation (e.g. UV radiation or DUV radiation); a support structure (e.g. a support structure) MT to support a patterning device (e.g. a mask) MA and connected to first positioning device PM to accurately position the patterning device with respect to item PL; a substrate table (e.g. a wafer table) WT for holding a substrate (e.g. a resist-coated wafer) W and connected to second positioning device PW for accurately positioning the substrate with respect to item PL; and a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjustor AM for adjusting the angular intensity distribution of the beam. Generally, at least the outer and/or inner radial extent (commonly referred to as R-outer and cy-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In some instances it is desired to image one or more patterns onto a substrate, and then subsequently invert the substrate and image one or patterns onto its opposite side. Where this is done, it is often desired that the pattern exposed on the upper surface of the substrate aligns correctly with the pattern already provided on the lower surface of the substrate. One way in which this may be achieved is by using a so-called front to backside alignment system, for example as described in U.S. Pat. No. 6,768,539 which is incorporated herein by reference.

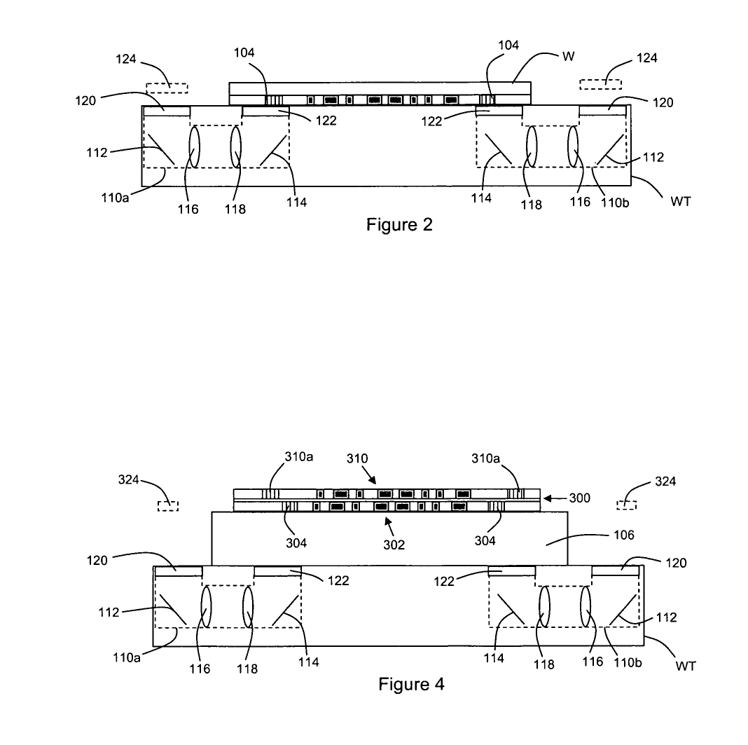

FIG. 2 shows a substrate W on the substrate table WT. The substrate table is arranged to allow alignment of a pattern to be projected onto an upper surface of the substrate, with respect to alignment marks 104 provided on a lower surface of the substrate.

An optical system is built into the substrate table WT for providing optical access to the alignment marks 104. The optical system comprises a pair of arms 110a, 110b, each of which contains an optical system. Each optical system consists of two mirrors, 112, 114 and two lenses 116, 118. The mirrors 112, 114 in each arm are inclined such that the sum of the angles that they make with the horizontal is 90°. In this way, a beam of light impinging vertically on one of the mirrors will remain vertical when reflected off the other mirror. Other ways of obtaining the 180° change in direction may be used. For instance, the lenses and the mounting may be designed in such a way that they may take account of a large part of the direction change, as long as the total of the optical system provides a direction change of 180°. Windows 120, 122 are provided in the substrate table WT above the mirrors 112, 114.

In use, radiation (e.g. infra-red radiation) is directed from an alignment system (not shown) located in the lithographic apparatus above the substrate table WT into one of the arms 10a. The radiation passes through the window 120 onto a first one of the mirrors 112, through lenses 116 and 118, onto a second one of the mirrors 114 and then through the window 122 onto the alignment mark 104. Light is reflected off portions of the alignment mark 104 and returns along the arm 110a towards the alignment system. The mirrors 112, 114 and lenses 116, 118 are arranged such that an image 124 of the alignment mark 104 is formed.

The image 124 of the alignment mark 104 acts as a virtual alignment mark, and may be used for alignment by the alignment system (not shown) in the lithographic apparatus in the same way as an alignment mark which is conventionally positioned on an upper surface of the substrate W. The alignment system may be a conventional alignment system. Such systems are well known to those skilled in the art and are therefore not described here.

Once an alignment measurement has been performed using the first arm 110a, the substrate table WT is moved until the window 120 of the second arm 110b lies beneath the alignment system. The alignment measurement is then repeated using the second arm 110b.

Calibration of the front to backside alignment system may be required. In particular, it is usually desired to know how closely a pattern projected onto the upper surface of the substrate W is aligned to the pattern which already exists on the lower surface of the substrate (the alignment of the pattern on the upper surface of the substrate having been achieved using the images 124 of the alignment marks 104 provided on the lower surface of the substrate). In other words, the overlay error between a pattern provided on an upper surface of the substrate and a pattern provided on a lower surface of the substrate is desired to be measured. Measuring the overlay error during setup of the lithographic apparatus allows a reduction of the overlay error to be achieved when projecting patterns onto production substrates. The measurement of the overlay error is referred to here as a calibration of the front to backside alignment system.

In the prior art, such calibration has conventionally been performed using a glass substrate. Alignment marks and a pattern are projected onto resist provided on one side of the glass substrate, using a lithographic apparatus. The substrate is then sent to a specialist processing company, where the substrate is etched and has metal deposited onto it so that the alignment marks and pattern layer are clearly visible on the substrate. The substrate is then introduced into a lithographic apparatus with front to backside alignment capability, the substrate having been inverted such that the alignment marks and pattern are on a lower surface of the substrate. The substrate is aligned within the lithographic apparatus using images of the alignment marks formed by the optics 112-118 in the wafer table WT. A pattern is projected onto resist provided on the substrate. The displacement, i.e. overlay error, between the two patterns is then measured. It is possible to measure the overlay error since, due to the transparent nature of the glass, the pattern on both sides of the glass substrate can be seen. The overlay error, once measured, is used to adjust the aligned position of subsequent wafers that are patterned in the lithographic apparatus, such that the overlay error is removed or substantially removed.

Disadvantages of the prior art procedure are that it may require a specially made patterning device MA, and special processing of the substrate after patterning of the first side of the substrate. This is time consuming and expensive.

In an embodiment of the invention, the front to backside alignment system of a lithographic apparatus is calibrated using a semiconductor substrate which is bonded or attached in some other way to a glass carrier.

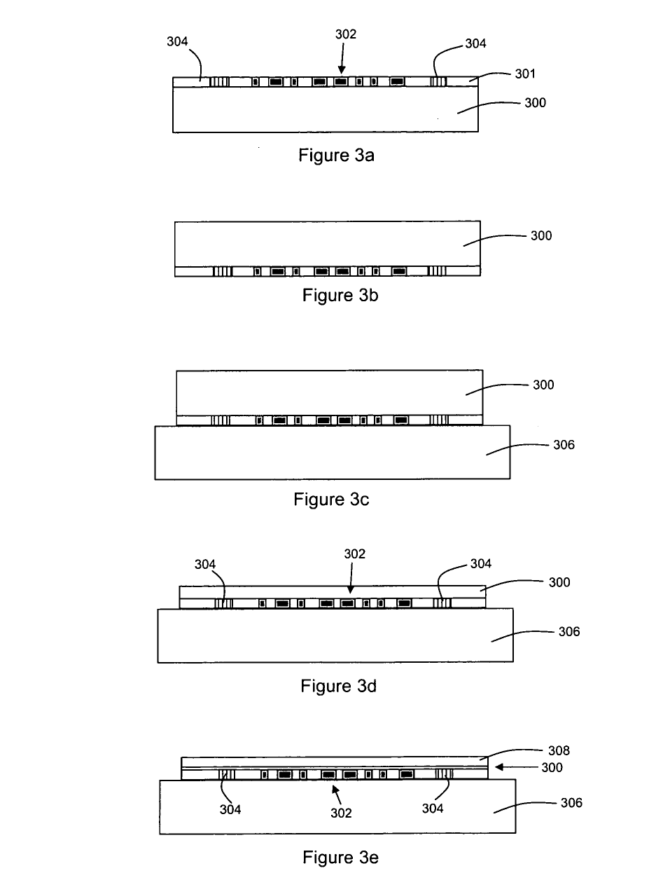

The manner in which the semiconductor substrate and glass carrier are put together is illustrated in FIG. 3. Referring to FIG. 3a a silicon substrate 300 is provided with a layer of resist 301 and is introduced into a front to backside alignment capable lithographic apparatus. A pattern 302 is projected onto the resist together with alignment marks 304. The pattern and the alignment marks may be projected onto the substrate at the same time. The substrate 300 is then removed from the lithographic apparatus, and is developed and etched. In an alternative approach, the alignment marks may be projected onto the substrate, the substrate may be developed and etched, after which the pattern may be projected onto the substrate then developed and etched. The pattern 302 may comprise a plurality of alignment marks, or may comprise product features (or simulated product features).

It is not necessary that a front to backside alignment capable lithographic apparatus is used to project the alignment marks 304 and pattern 302 onto the substrate 300. Any suitable lithographic apparatus may be used. The purpose of the alignment marks 304 and pattern 302 is to provide a reference against which a subsequently projected layer may be calibrated (as described below). Thus, all that is required in connection with the alignment marks 304 and pattern 302 is that they are projected with sufficient accuracy to be used as the reference for the calibration measurement.

As shown in FIG. 3b, the substrate 300 is inverted once it has been developed and etched.

As shown in FIG. 3c, the substrate 300 is attached to a glass carrier 306. The substrate may for example be bonded to the glass carrier using a suitable glue. Where this is done, the glue may be applied to areas of the substrate which are not patterned and do not have alignment marks. This is to avoid the possibility that the glue distorts the pattern or alignment marks when viewed through the glass carrier 306.

As shown in FIG. 3d, the substrate 300 is then ground down. This may be done for example until the substrate is around 100 microns thick (or possibly less). The substrate 300 is reduced in thickness to such an extent that the alignment marks 304 and pattern 302 are visible to the alignment system (not illustrated) through the substrate.

As shown in FIG. 3e, a layer of resist 308 is then applied to the substrate 300. The substrate 300 and carrier 306 are introduced into a front to backside alignment capable lithographic apparatus.

FIG. 4 shows the substrate 300 and carrier 306 on the substrate table WT of the lithographic apparatus. The lithographic apparatus aligns the substrate 300 using images 324 of alignment marks 304 on the lower surface of the substrate (the images are formed by the optics 112-118 in the substrate table WT). A pattern 310 is then imaged onto the substrate 300.

As can be seen in FIG. 4, there is an overlay error between the patterns 302,310 on opposite sides of the substrate (i.e. the patterns are not exactly aligned with one another).

The substrate is removed from the lithographic apparatus and is developed and etched. A separate metrology apparatus may then be used to measure the overlay error between the patterns 302, 310 on opposite sides of the substrates. This may be done for example by using the metrology apparatus to view the pattern 310 on the upper surface of the substrate 300 and record its position, and to then subsequently view the pattern 302 on the lower surface of the substrate by looking through the substrate and record its position. The recorded positions of the two patterns may then be compared in order to determine the overlay error.

In an embodiment, the lithographic apparatus may be used to view the patterns 310, 302 on the upper and lower surfaces of the substrate, and record their positions. The measurement may be performed for example by the alignment system The lithographic apparatus may thus be used to determine the overlay error without requiring measurements to be performed using a metrology apparatus.

In an embodiment, the lithographic apparatus may be used to view the patterns 310, 302 on the upper and lower surfaces of the substrate 300, and record their positions, without the second pattern having been developed and etched. The pattern 310 on the upper surface of the substrate 300 may be seen as a ‘latent image’ in the resist. In other words, although the resist has not been developed, an image is present in the resist (known as the latent image) which is visible to the alignment system. The alignment system of the lithographic apparatus may be used to measure the positions of the latent images on the upper surface of the substrate, and thereby determine the overlay error. This may be done immediately after the pattern 310 has been projected onto the upper surface of the substrate 300 by the lithographic apparatus. This allows calibration of the overlay error to be performed more quickly.

Once the overlay error has been measured, the overlay error is recorded (for example in a memory which may be accessed by the lithographic apparatus). The measured overlay error is used to correct alignment measurements which are subsequently performed by the lithographic apparatus for projection of patterns onto substrates. For example, it may be determined that the front to backside alignment optics of a given lithographic apparatus give rise to an error of −2 nm in the x-direction. That is to say, measuring the position of alignment marks 304 using the front to backside alignment system will cause the aligned position of the substrate to be 2 nm away in the negative x-direction from the correct aligned position. When the substrate is positioned to allow a pattern to be projected onto it, the position to which the substrate is moved (using the substrate table WT) takes into account the −2 nm error. In other words, the substrate is moved 2 nm in the negative x-direction from the position that it would have had. In this way, the overlay error that would have arisen due to the front to backside alignment optics is removed.

In FIG. 4 the patterns 310, 302 provided on the upper and lower surfaces of the substrate 300 are the same (although the patterns are only shown schematically). The misalignment between the patterns 310, 302 which is seen is due to an overlay error of the lithographic apparatus. However, it may be desired to deliberately introduce an offset between the patterns 310, 302. This may be done for example to allow the alignment system (not illustrated) of the lithographic apparatus to view parts of the pattern on the lower surface of the substrate without them being obscured by corresponding parts of the pattern on the upper surface of the substrate. Since the deliberately introduced offset is already known, once the separation between the patterns 310, 302 on opposite sides of the substrate has been measured, the deliberately introduced offset may be subtracted such that the overlay error remains.

In FIG. 4 the pattern 310 projected onto the substrate includes alignment marks 310a. These alignment marks include a deliberately introduced offset, as an example of how the offset may be used. The offset is not applied to the remainder of the pattern. In some instances a deliberately introduced offset may be applied to all of the pattern 310.

In some instances the pattern 310 projected onto the substrate may comprise only alignment marks. Alternatively, the pattern projected onto the substrate may include no alignment marks. Where this is done, the position of the pattern may be determined for example by measuring the positions of features of the pattern.

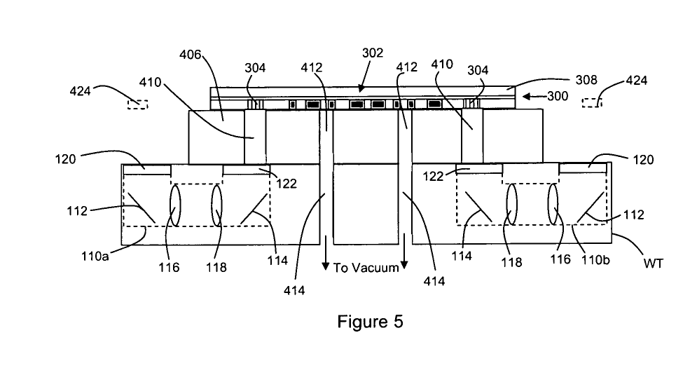

In some instances openings may be provided in the carrier, which pass up through the carrier to the lower surface of the substrate. For example, as shown in FIG. 5, a carrier 406 is provided with two openings 410 and two additional openings 412. A substrate 300 which is shown on top of the carrier 406 corresponds with the substrate in FIG. 4. A substrate table WT which is shown in FIG. 5 corresponds generally with the substrate table WT shown in FIG. 4.

The first two openings 410 provided in the carrier 406 are positioned such that when the substrate 300 is on top of the carrier 406, the alignment marks 304 on the lower surface of the substrate 300 are located over the openings 410. This means that during alignment, radiation from the alignment system (not illustrated) passes via the openings 410 to the alignment marks 304 rather than having to pass through the body of the carrier 406. Although the body of the carrier 406 may be formed from quartz (or some other transparent material), passage of radiation from the alignment system through the body of the carrier may introduce some distortion into the images 424 of the alignment marks (or modify their positions), thereby introducing an error into the measured position of the alignment marks on the lower surface of the substrate. In the carrier 406 shown in FIG. 5 this error is avoided since the radiation passes through openings 410 in the carrier 406 rather than passing through the body of the carrier. In addition, errors which may occur due to reflections from the carrier 406 (e.g. ghost reflections) are avoided.

When openings 410 are provided in the carrier 406 beneath the alignment marks 304, it is no longer necessary for the carrier 406 to be transparent. The carrier may therefore be formed from any suitable opaque material, such as for example aluminum or some other metal. The carrier may alternatively be formed from a ceramic, for example Zerodur (available from Schott AG).

The windows 120, 122 provided in the substrate table WT may be formed from quartz, or some other suitable transparent material. Alternatively, at least some of the windows 120, 122 may be simply open spaces, without any material being present. This may avoid distortion or other errors being introduced into the images 424 of the alignment marks 304 by the windows.

Additional openings 412 may also be provided in the carrier 406. These openings may be positioned such that when the carrier 406 is on the substrate table WT, the openings align with corresponding openings 414 provided in the substrate table. Some conventional substrate tables are provided with such openings, the openings being arranged to provide a vacuum which in use draws a conventional substrate onto the substrate table. This is done to ensure that the substrate is rigidly fixed to the substrate table during exposure in the lithographic apparatus. Where openings 412 are provided in the carrier 406 which align with the vacuum openings 414 in the substrate table, the vacuum passes through to the lower surface of the substrate 300. This has the effect of drawing the substrate 300 towards the substrate table WT.

Where a carrier 406 of the type shown in FIG. 5 is used, the substrate 300 may be bonded to the carrier in a way which is less rigid may would otherwise be the case. For example, bonding of the substrate 300 to the carrier 406 may be achieved by providing a thin layer of water at some locations between the substrate and the carrier. For example the water may be provided as a ring close to the outer edge of the substrate. Where this is done, surface tension forces will hold the substrate 300 and the carrier 406 together. When the substrate and carrier are positioned on the substrate table WT, the vacuum delivered from the substrate table passes through the carrier 406 and draws the substrate 300 towards the substrate table WT, thereby ensuring that the substrate is rigidly fixed in position relative to the substrate table.

The alignment marks 304, 312 used by the embodiment of the invention may be any suitable alignment marks. For example, they may comprise diffractive gratings or may comprise crosses or other devices. The marks may be arranged such that they appear identical irrespective of whether they are viewed from above or below. Alternatively, if the alignment marks do not have this property, the alignment system may be configured such that it is capable of measuring the positions of alignment marks which appear different when viewed from below as compared with being viewed from above.

The alignment system of the lithographic apparatus may for example be of the type described in U.S. Pat. No. 6,297,876 (herein incorporated by reference) or of the type described in U.S. Pat. No. 6,961,116 (herein incorporated by reference).

Although in the above description an alignment system of the lithographic apparatus is used to measure the position of the alignment marks and the position of the pattern, a separate dedicated measurement system may be used.

The term overlay error is used in the above description to mean an offset between patterns which arises as a result of imperfections in the lithographic apparatus (for example misalignment of the optics provided in the substrate table WT).

While specific embodiments of the invention have been described above, it will be appreciated that the invention may be practiced otherwise than as described. The description is not intended to limit the invention.

What is claimed is:

1. A method of calibrating a front to backside alignment capable lithographic apparatus, the method comprising:
attaching a substrate with a plurality of alignment marks to a carrier, the substrate being arranged such that the alignment marks face towards the carrier;
reducing the thickness of the substrate by removing part of the substrate;
introducing the substrate and the carrier into the lithographic apparatus;
using an alignment system of the lithographic apparatus to measure the positions of images of alignment marks formed by optics in a substrate table of the lithographic apparatus;
projecting a pattern onto the substrate, the position of the pattern being determined according to the measured positions of the alignment marks;
measuring the position of the projected pattern and the position of alignment marks provided on the opposite side of the substrate, the position of the alignment marks provided on the opposite side of the substrate being measured by directing radiation through the substrate; and
comparing the measured positions in order to determine an overlay error.

2. The method of claim 1, wherein the substrate is attached to the carrier by gluing the substrate to the carrier.

3. The method of claim 2, wherein the glue is applied at locations on the substrate which do not bear alignment marks.

4. The method of claim 1, wherein the carrier is transparent.

5. The method of claim 1, wherein the carrier is opaque and is provided with openings at positions corresponding with positions of the alignment marks.

6. The method of claim 1, further comprising applying a vacuum to substrate, the vacuum passing through holes in the carrier and acting to draw the substrate onto the carrier.

7. The method of claim 6, wherein the substrate is attached to the carrier by providing fluid between them.

8. The method of claim 1, wherein the measurements of the position of the projected pattern and the position of alignment marks provided on the opposite side of the substrate are performed by the lithographic apparatus.

9. The method of claim 1, wherein the measurements of the position of the projected pattern and the position of alignment marks provided on the opposite side of the substrate are performed by the alignment system of the lithographic apparatus.

10. The method of claim 1, wherein the measurements of the position of the projected pattern and the position of alignment marks provided on the opposite side of the substrate are performed by a metrology apparatus which does not form part of the lithographic apparatus.

11. The method of claim 1, wherein the position of the projected pattern is measured by measuring the latent image projected by the lithographic apparatus.

12. The method of claim 1, wherein the position of the projected pattern is measured after the projected pattern has been developed and etched.

13. The method of claim 1, wherein the pattern projected onto the substrate after the substrate has been attached to the carrier is offset with respect to the previously projected alignment marks, so that the pattern does not lie over the alignment marks.

14. The method of claim 1, wherein the pattern projected onto the substrate comprises a plurality of alignment marks.

15. The method of claim 1, wherein the reduced thickness of the lithographic substrate is 100 microns or less.

16. The method of claim 1, wherein the overlay error is used to correct the alignment of patterns which are subsequently projected using the lithographic apparatus.

17. A substrate carrier arranged to hold a substrate, wherein the substrate carrier is provided with a plurality of openings which pass from an upper surface of the substrate carrier to a lower surface of the substrate carrier, the openings being positioned such that in use alignment marks provided on an underside of the substrate are located over the openings.

18. The substrate carrier of claim 17, wherein the substrate carrier is made from an opaque material.

19. The substrate carrier of claim 17, wherein the substrate carrier is provided with a plurality of additional openings which pass from the upper surface of the substrate carrier to the lower surface of the substrate carrier, the openings being positioned such that in use a vacuum applied from a substrate table of the lithographic apparatus may pass through the substrate carrier to a substrate held on the carrier.
